(19) United States
(12) Patent Application Publication
(10) Pub. No.: US 2026/0167572 A1
(43) Pub. Date: Jun. 18, 2026

(54) Wet-Cast Concrete with Lower Global Warming Potential Through Sequestration of Solid Carbon from Methane Pyrolysis

(71) Applicants: Meimanat Soleimanifar, North Vancouver (CA); Meghdad Hoseini, North Vancouver (CA); Sadegh Kazemi, North Vancouver (CA)

(72) Inventors: Meimanat Soleimanifar, North Vancouver (CA); Meghdad Hoseini, North Vancouver (CA); Sadegh Kazemi, North Vancouver (CA)

(21) Appl. No.: 19/421,909

(22) Filed: Dec. 16, 2025

Related U.S. Application Data
(60) Provisional application No. 63/735,885, filed on Dec. 18, 2024.
(60) Provisional application No. 63/793,933, filed on Apr. 24, 2025.
(60) Provisional application No. 63/803,537, filed on May 10, 2025.

(51) Int. Cl. C04B 28/04; C04B 14/02

(52) U.S. Cl. CPC C04B 28/04; C04B 14/022

(57) ABSTRACT

A wet-cast concrete composition includes a binder composition. The binder composition includes solid carbon equal to or more than one percent by mass of the binder composition. The wet-cast concrete composition further comprises Portland cement, aggregates, and water such that the concrete composition slumps. The disclosure also includes at least one method of preparing wet-cast concrete.

### TECHNICAL FIELD

The disclosure relates to building materials and the composite concrete. More specifically, the disclosure relates to wet-cast concrete with a higher water-to-cement ratio and lower global warming potential than traditional concrete.

### BACKGROUND

Concrete is an artificial composite material including aggregates, sand, binders, water, and additives or admixtures. The binder composition is essential in concrete formulations as it binds aggregates, ensuring structural integrity. Solid carbon adds durability, sustainability, and improved properties, while Portland cement ensures proper setting and hardening. Portland cement, a hydraulic cement, includes CaO, Al₂O₃, Fe₂O₃, MgO, SiO₂, and SO₃. The production of Portland cement, a process called calcination or lime-burning, includes converting limestone (calcium carbonate, CaCO₃) to make quicklime (calcium oxide, CaO) and carbon dioxide (CO₂) as a byproduct. This single chemical reaction is a major source of carbon dioxide emissions. This accounting doesn't include the energy needed to raise the limestone to over 825° C. Thus, the use of traditional concrete as a building material is a source of GreenHouse Gas (GHG) emissions (GHE).

Further, wet-cast concrete is a type of concrete mix that is more flowable (e.g., includes a higher water content, is more workable). This consistency allows the wet-cast concrete to be easily poured into molds or forms, thereby making it ideal for creating intricate or large precast concrete pieces. Once poured, the concrete is allowed to cure in a controlled environment, after which it is removed from the mold and eventually prepared for use.

Therefore, features such as higher water-to-cement ratio, better consistency, and slump make the wet-cast concrete ideal for detailed designs and applications, such as cast-in-place and pre-cast concrete. Dry cast concrete with a low water content, stiff consistency, and zero slump is not an ideal choice here.

### SUMMARY

This section is intended to introduce certain objectives and aspects of the present disclosure in a simplified manner.

A wet-cast concrete composition includes a binder composition. The binder composition includes solid carbon equal to or more than one percent by mass of the binder composition. The wet-cast concrete composition further comprises Portland cement, aggregates, and water such that the concrete composition slumps.

A method of preparing a wet-cast concrete, including preparing one or more forms, and combining Portland cement, solid carbon, and aggregates in specified proportions to form a binder composition. The specified portion includes the solid carbon is equal to or more than one percent by mass of the binder composition. The method further includes mixing the binder composition with water and aggregates to form an uncured concrete mixture such that the concrete composition slumps, and placing the uncured concrete mixture in one or more forms.

A system, device, article, composition of matter, or method as described herein.

This summary does not necessarily describe the entire scope of all aspects. Other aspects, features, and advantages will be apparent to those of ordinary skill in the art upon review of the following description of specific embodiments.

### BRIEF DESCRIPTION OF DRAWINGS

Systems, devices, articles, and methods are described in greater detail herein with reference to the following figures:

FIG. 1 is a schematic view of a concrete plant used to produce wet-cast concrete products.

FIG. 2 is a flowchart illustrating a method of operation of the wet-cast concrete plant.

FIG. 3 is a plot illustrating one or more binder compositions.

The above-mentioned drawings illustrate exemplary embodiments of the disclosed methods and systems in which, like reference numerals refer to the same parts throughout the different drawings. Components in the drawings are not necessarily to scale; emphasis instead being placed upon clearly illustrating the principles of the present invention. Some drawings may indicate the components using block diagrams and may not represent the internal circuitry of each component. Also, the embodiments shown in the figures are not to be construed as limiting the disclosure but only as illustrative examples.

### DETAILED DESCRIPTION

In the following description, associated drawings, included claims, and other parts of the document, various details are set forth to provide a detailed understanding of the disclosure and embodiments thereof. It will be apparent, however, that the disclosed embodiments may be practiced without these details. Several features described hereafter can each be used independently of one another or with any combination of other features.

In view of the above-mentioned problems and challenges, the Applicant appreciates there is a need for advanced concrete formulations and production methods having a lower global warming potential than traditional concrete. Unlike traditional wet-cast concrete formulations that rely solely on Portland cement, which contributes significantly to carbon emissions, the present disclosure integrates solid carbon materials or carbon dioxide sequestration techniques to lower the global warming potential of building material while maintaining suitable structural integrity.

Unlike traditional concrete, which relies on energy-intensive processes, this disclosure shows sequestering carbon or utilizing byproducts such as solid carbon from methane pyrolysis. Concrete with lower global warming potential includes concrete compositions incorporating carbon-based material from various sources, including methane pyrolysis (MP) and direct air capture (DAC) processes. The carbon material may include solid carbon, carbon dioxide, or both. In some embodiments, the carbon added is solid carbon.

Applicant appreciates that the solid carbon byproduct of methane pyrolysis may be used in concrete compositions. Methane pyrolysis, a process that thermally decomposes methane into hydrogen gas and solid carbon, offers a CO₂ emission-free pathway to produce hydrogen. With adoption Applicant believes substantial quantities of solid carbon (e.g., carbon black) will become available. Combustion is not a suitable use. Applicant proposes permanent carbon sequestration, preventing release as CO₂ and mitigating climate change. Also, finding applications for solid carbon ensures economic viability, transforming it into valuable products like construction materials, which can significantly lower the cost of producing hydrogen. Finally, incorporating solid carbon aligns with circular economy principles, reducing reliance on virgin resources.

Applicant has observed that sequestering carbon in concrete formulations does not appreciably alter the mechanical and physical properties of the concrete, while significantly contributing to the development of carbon-negative concrete mixes.

The term “a” or “an” when used in conjunction with the terms “comprise”, “include”, “comprising”, or “including” in the claims or the specification may mean “one”, “one or more”, “at least one”, and “a plurality” unless the content dictates otherwise. Similarly, the word “another” means “additional” or “at least a second” unless the content clearly dictates otherwise. The term “and/or” herein when used in association with a list of items means any one or more of the items comprising that list.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, or coupling can indicate that two units or devices are directly connected to one another or connected to one another through one or more intermediate elements or devices by an electrical element, electrical signal or a mechanical element depending on the particular context.

“Portland cement” herein refers to a binder, a hydraulic cement, including CaO, Al₂O₃, Fe₂O₃, MgO, SiO₂, and SO₃.

“Fine aggregate” herein refers to small-sized particles that contribute workable concrete mix and a smooth finish. These particles typically have a diameter of less than 9.5 mm and often smaller than one (1) mm. Examples include sand such as natural sand, manufactured sand; crushed stone sand; or stone dust.

“Coarse aggregate” herein refers to granular materials used in concrete. comprising particles that typically range in size from 5 mm to 40 mm. Coarse aggregates often appear in types such as crushed stone, produced by crushing hard rocks like granite or limestone; crushed concrete; or gravel, a naturally occurring material that is more rounded.

“Supplementary cementitious materials (SCMs)” are materials used in conjunction with Portland cement to enhance the properties of concrete. They can be added to concrete mixtures to improve durability, decrease permeability, and enhance overall performance through hydraulic or pozzolanic activity. Examples of SCMs include fly ash, pozzolans, silica fume, (blast furnace) slag, and organic matter ash. Fly ash is a byproduct of coal combustion. Slag or Ground Granulated Blast Furnace Slag (GGBFS) is a glassy composition created in ironmaking and steel-making processes. Silica fume is a byproduct of the production of silicon and ferrosilicon alloys. Natural pozzolans are earths like calcined clays, shale, and metakaolin that react with calcium hydroxide to form compounds with cementitious properties. Organic matter ash, rich in silica, like rice husk ash may be used as an SCM.

“Solid carbon” herein refers to carbon in a solid state and includes carbon black, activated carbon, or graphite. Carbon black is a fine black powder made primarily of elemental carbon produced by the incomplete combustion of heavy petroleum products, such as tar and ethylene cracking tar. Typically ranges from 10 to 500 nanometers. Activated carbon, also known as activated charcoal, is a form of carbon that has been processed to have small, low-volume pores that increase the surface area available for adsorption or chemical reactions. Graphite is a crystalline allotrope of carbon, which includes nano fiber carbon, nano carbon, and micro carbon. Graphite may be a byproduct of Methane pyrolysis, Kværner process, or the like.

“Carbon black” (may also be interchangeably referred to as “Nano Carbon”) is a fine black powder, typically ranging from 10 to 500 nanometers, made primarily of elemental carbon produced by the incomplete combustion of heavy petroleum products, such as tar and ethylene cracking tar. The carbon black may partially replace the binder material in the mix.

Coarse carbon typically ranges from 100-1000 micrometers and is a form of carbon that has been processed to have small, low-volume pores that increase the surface area available for adsorption or chemical reactions. The coarse carbon may partially replace the fine aggregate material in the mix.

Graphite is a crystalline allotrope of carbon, characterized by its layered structure composed of hexagonally arranged carbon atoms. Graphite may be a byproduct of Methane pyrolysis, Kværner process, or the like. Graphite from MP includes particles in the range of 10-100 micrometers. Graphite may partially replace the binder material in the mix.

Nano fiber carbon refers to carbon in solid state with particle sizes characterized by diameters in the range from 10-100 nanometers and lengths in 1-5 microns. Nano fiber carbon may be a product of CO₂ (from direct air captured) reacting with methane. In shape, nano fiber carbon can be elongate, conical, plate-like, or cup-like. Nano fiber carbon may be used as an additive in the mix.

An admixture or additive is a material added to concrete, other than water, aggregates, cementitious materials, and fiber reinforcement, to modify properties. These compounds or materials are incorporated into the mix before or during mixing to enhance workability, durability, or strength of the mix or concrete.

Wet cast concrete is more fluid constancy typically coming from has a higher water-to-dry ingredient ratio in the mix. The mix will fail a zero-slump test. Wet cast concrete is poured into molds and, optionally, vibrated to remove air bubbles. Wet cast concrete is ideal for detailed designs and applications such as cast-in-place or precast concrete. Dry cast concrete has a lower water-to-cement ratio, dry cast concrete has a stiff consistency and zero slump. It is compressed into molds using heavy machinery and cures quickly. Dry cast concrete may be used for structural elements like pipes, manholes, and retaining wall blocks, and pavers.

ASTM C143 and AASHTO T 119 are the standard test methods for the slump of hydraulic-cement concrete. Dry cast concrete is said not to slump if, in a concrete sample loses less than 25 mm in height when the slump cone—a temporary form—is removed.

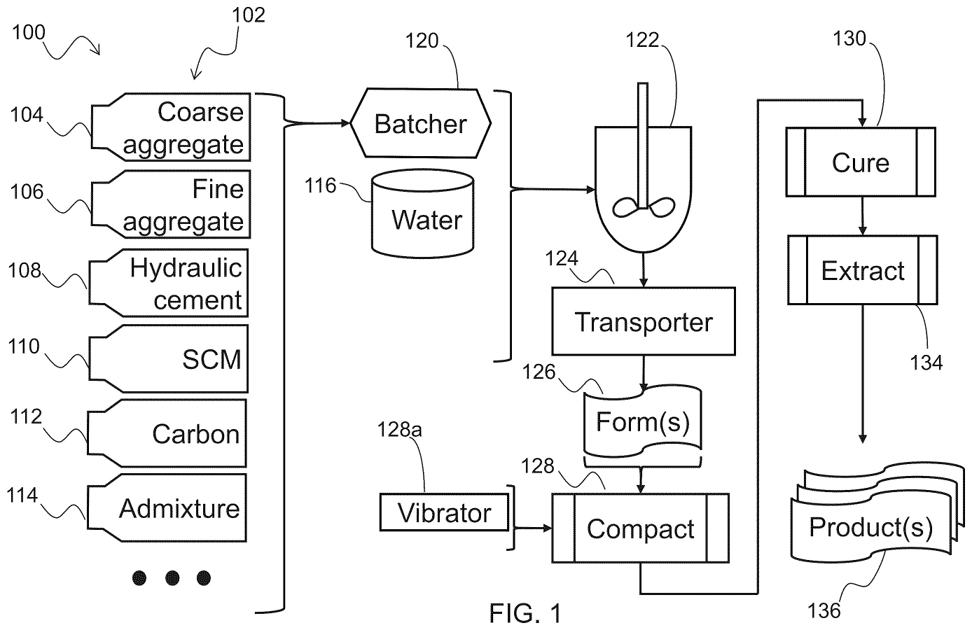

Referring now to FIG. 1, which illustrates a schematic of an exemplary concrete plant 100 including examples of devices and methods used to produce wet-cast concrete products. Plant 100 includes a plurality of input dry materials 102 such as coarse aggregate 104, fine aggregate 106, hydraulic cement 108, supplementary cementitious materials (SCM) 110, carbon 112 and admixture(s) 114. Examples of admixtures include air entrainers, air detrainers, hydrocizer, compaction aids, efflorescence reducers, plasticizers, pump aids, set accelerators, set retarders (set delayers), tints, water repellent additives, viscosity modifiers, or the like.

Plant 100 includes a batcher or a doser 120 that combines the plurality of input dry materials 102, and Portland cement, solid carbon, and aggregates; and a mixer 122 that accepts the output of the batcher 120 with water 116. In some embodiments, batcher 120 is coupled to mixer 122 by a conveyor belt. Examples of mixer 122 include an MF-1500 turbo pan mixer by Poyatos of Albolote, GR, ES. The operator of plant 100 prepares the at least one form 126. Concrete forms are temporary or permanent molds that hold concrete in place to shape the concrete until the concrete can hold its own shape. In some embodiments, reusable forms are used.

In operation, the operator prepares at least one form 126, wherein the one or more forms refer to a shape of the concrete. Further, the at least one form 126 defines, in part, the shape of a concrete product. In an embodiment, at least one form 126 may include positive elements (e.g., buck, pattern, plug) in addition to negative elements defined by the inner surface of at least one form 126. The at least one form 126 may be placed on a palette or cookie sheet, and, in some embodiments, the palette or cookie sheet form part of the inter surface of form(s) 126.

In operation, mixer 122 combines the plurality of dry ingredients 102 in a specified proportion to form a binder composition as explained later in the disclosure. Further, mixer 122 mixes the binding composition with water 116 to form an uncured mixture or mix such that the concrete composition slumps.

In some embodiments, the operator transfers the uncured mixture in the mixer 122 to the at least one form 126. In some embodiments, a transporter 120 (e.g., a concrete truck) receives the uncured mixture from mixer 122 and transports the mix to the at least one form 126.

In some embodiments, plant 100 includes one or more compactors that, in response to control signals, compact the uncured mixture in the at least one form 126. As shown, plant 100 includes a compact method 128. Examples of compactors include vibrators.

In operation, the concrete is hardened in the cure method 130. The times used in the cure method 130 vary with environmental conditions (e.g., temperature and humidity), composition (e.g., cement, SCM, and water content), and application. The concrete starts to harden within 2 to 4 hours after being cast. After about 8 to 48 hours, the concrete can be removed from the at least one form 126 and handled without causing damage. Cure method 130 includes processes that allow the concrete to cure or reach the desired strength and durability. In some embodiments, plant 100 cures the concrete, in part, in cure method 130, in an elevated carbon dioxide environment.

In some embodiments, plant 100 includes one or more extractors 134 that, in response to control signals, remove the concrete from the at least one form 126. The one or more extractors 134 may be part of a material handling system. The material handling system may include an accumulator to transfer cookie sheets and the at least one form 126 within plant 100. Examples of an accumulator include a TIGER Robotic Pallet Accumulator. Plant 100 may include a transporter such as a TIGER Pallet Transporter System. TIGER products are sold by Pathfinder of Holland, MI, US. In some embodiments, plant 100 includes a stacker-destacker. In some embodiments, the material-handling system includes pneumatic, electric, hydraulic or combined operations.

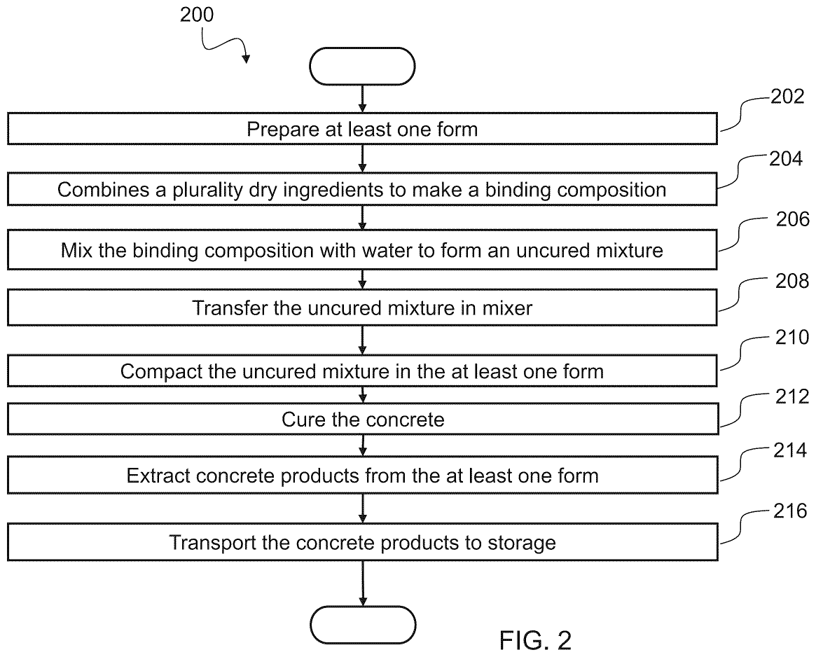

Further, in some embodiments, wet-cast concrete products 136, formed after the cure method 130, are transported to storage as explained later in FIG. 2. Further details of the operation of plant 100 are described in U.S. patent appl. Nos. 63/735,885 and 63/803,537.

Referring now to FIG. 2, which illustrates an exemplary method 200 of operation of the wet-cast concrete plant. Method 200 may be performed by plant 100.

At 202, the batcher or a doser 120 prepares the at least one form 126, wherein the one or more forms refer to a shape of the concrete. In some embodiments, reusable forms are used in operation.

At 204, the mixer 122 combines the plurality of dry ingredients 102 in a correct proportion to form a binder composition. In some embodiments, mixer 122 combines Portland cement, solid carbon, aggregates in specified proportions to form a binder composition, wherein the specified proportions include the solid carbon equal to or more than one percent by mass of the binder composition. In some embodiments, the specified proportions include solid carbon equal to or more than one percent by mass of the binder composition and supplementary cementitious materials. In some embodiments, the solid carbon is carbon black, activated carbon, or graphite. In some embodiments, at 204, the plant combines a plurality of binders into a binder composition including solid carbon in a range between one (1) percent and five (5) percent mass of the binder composition.

At 206, mixer 122 mixes the binding composition with water 116 to form an uncured mixture or mix such that the concrete composition slumps. The mixer 122 combines the output of the batcher 120 with water 116.

At 208, transporter 124 transfers the uncured mixture in mixer 122 to at least one form 126. In some embodiments, transporter 124 moves the mix to, for example, a building site or another part of plant 100.

At 210, one or more compactors 128, in response to control signals, compact the uncured mixture in the at least one form 126. Examples of compactors include vibrators 128a.

At 212, plant 100 cures the concrete. Curing is a process where concrete transitions from a plastic state to a solid state. The process begins at 204 and continues through the method to 214. Typical timelines are tens of minutes to days. In some embodiments, including precast concrete, the concrete gains enough strength to be moved to curing rooms. Several factors influence the curing time, durability, finish, and strength of concrete.

Key variables include the batching and casting temperature, batch ingredients, ambient environmental conditions, member thickness, form configuration, compaction methods and the curing regime. Concrete cures faster in warmer temperatures due to accelerated hydration reactions, but excessive heat can cause water to evaporate too quickly, leading to potential defects. The batch ingredients play a significant role in determining cure time; for instance, the type of binder and admixtures used can alter the rate of hydration. The water-to-cement ratio is another critical factor. A higher ratio may speed up curing but can compromise strength, while a lower ratio enhances durability at the cost of longer curing times. Thicker concrete members take more time to cure due to the larger volume of material undergoing hydration. Environmental factors such as wind, humidity, and sunlight also influence the curing process. To optimize curing, the use of curing compounds or sealants can help retain moisture and protect the surface.

At 214, the one or more extractors 134, in response to control signals, remove the concrete from the at least one form 126. The one or more extractors 134 may be part of a material handling system.

At 216, the wet-cast concrete products 136 formed after step 214 are transported to storage.

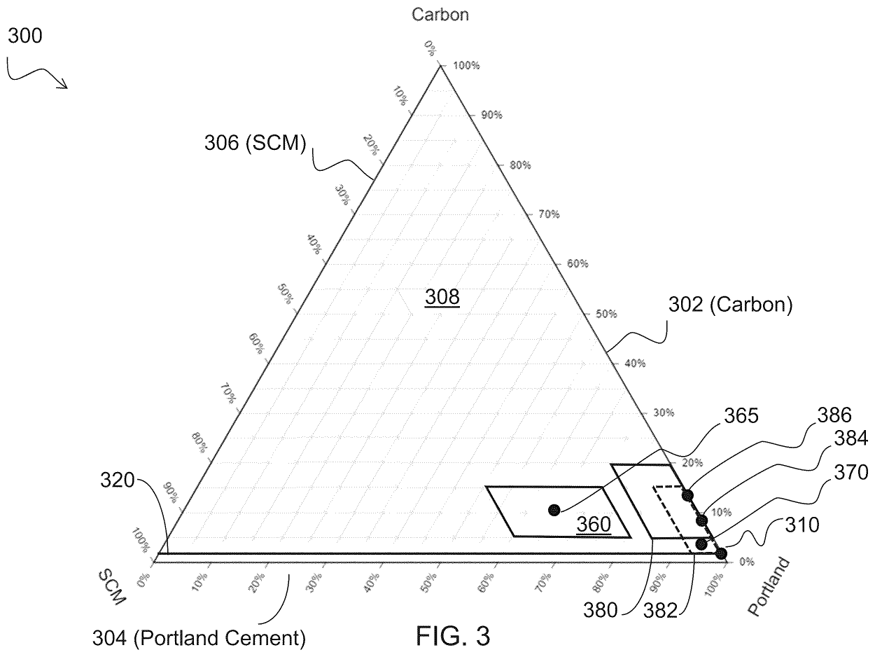

Turning to FIG. 3, which illustrates a ternary plot 300. A ternary plot is a graphical representation of the proportions of three variables that sum to a constant. Plot 300 includes a first axis 302 on the right side corresponding to a portion of carbon in a binder composition. A second axis 304 on the bottom corresponds to a portion of Portland cement in the binder composition. A third axis 306 on the left side corresponds to a portion of SCM in the binder composition. Plot 300 includes a plot area 308. A location on plot area 308 defines a binder composition. For example, location 310 corresponds to a binder composition including 1 percent carbon and 99 percent Portland cement.

Lines in plot area 308 define metes or bounds on compositions. For example, line 320 is one (1) percent carbon, and 99 percent Portland cement or SCM combined.

Areas and lines in plot area 308 define ranges of values for binder compositions. Aspects of the ternary plot 300 in the context of concrete are described in U.S. patent appl. Nos. 63/735,885 and 63/803,537.

Some embodiments include a binder composition including a binder composition comprising solid carbon at about ten (10) percent, SCM at about 25 percent, and Portland cement as the principal component of the remainder. Point 365 in region 360 illustrates an example of the binder composition. Point 365 corresponds to 65% Portland cement, 25% SCM, and 10% carbon. Region 360 may be defined by four corners: lower right 80% Portland cement, 15% SCM, and 5% carbon; upper right 70% Portland cement, 15% SCM, and 15% carbon; upper left 50% Portland cement, 35% SCM, and 15% carbon; and lower left 60% Portland cement, 35% SCM, and 5% carbon.

Some embodiments include a binder composition including a binder composition comprising solid carbon at about two (2) to three (3) percent of binder mass, and Portland cement as the principal component of the remainder. Point 370 illustrates an example of the binder composition corresponding to 94% Portland cement, 2% SCM, and 4% carbon.

Some embodiments include a binder composition including a binder composition comprising solid carbon, Portland cement, and optionally SCM. For example, region 380 corresponds to 95% Portland cement, no or trace SCM, and 5% carbon in lower right corner; 80% Portland cement, no or trace SCM, and 20% carbon in upper right; 70% Portland cement, 10% SCM, and 20% carbon in upper left; and 85% Portland cement, 10% SCM, and 5% carbon in lower left. For example, region 382 is defined on lower right by 98% Portland cement, no or trace SCM, and 2% carbon; upper right by 85% Portland cement, no or trace SCM, and 15% carbon; upper left by 80% Portland cement, 5% SCM, and 15% carbon; and lower left by 93% Portland cement, 5% SCM, and 2% carbon.

Point 384 illustrates a binder mix corresponding to 92% Portland cement, no or trace SCM, and 8% carbon. This is very close to the composition shared in Table 2 herein. Point 386 illustrates a binder mix corresponding to 86% Portland cement, no or trace SCM, and 14% carbon. This is very close to the composition shared in Table 1 herein.

The present disclosure refers to one or more concrete compositions.

Reference concrete is some concrete with standard levels of aggregate, and 100 percent hydraulic cement with negligible content of carbon or SCM, used as a baseline for comparison. The carbon present in the reference concrete may be used for tinting the colour and in some examples is one percent or less of the binders. The values for carbon herein are expressed as proportion to the mass of all binders or just the carbons, as will be clear from the context.

Some embodiments of a concrete mixture comprise the following by mass in kilograms, shown in the following Table 1. As shown in Table 1, the binder composition includes a binder composition comprising coarse carbon at about 3.0 percent of mass of ingredients and Portland cement.

TABLE 1
An example wet cast concrete mix containing coarse carbon

| | Dry Weight per Cubic |
|---|---|
| Mix Component | Meter (Kg) |
| Coarse Aggregate | 893 |
| Fine Aggregate | 826 |
| Cement | 397 |
| Fly Ash (FA) | 0 |
| Silica Fume (SF) | 0 |
| Water | 159 |
| Air Entertainment | 0.11 |
| Admixture | |
| Super Plasticizer | 3 |
| Carbon Black | 0 |
| Graphite | 0 |
| Coarse Carbon (CC) | 67 |

Some embodiments of a concrete mixture comprise the following by mass in kilograms, shown in the following Table 2. As shown in Table 2, the concrete composition includes one (1) to two (2) percent of ingredients mass, and the binder composition includes a binder composition comprising solid carbon at about half a percent, and Portland cement for the principal component of the remainder. Table 2:

TABLE 2
An example wet cast concrete mix containing two types of solid carbon,
including 0.5 percent carbon black and 1 percent coarse carbon.

| | Dry Weight per Cubic |
|---|---|
| Mix Component | Meter (Kg) |
| Coarse Aggregate | 926 |
| Fine Aggregate | 903 |
| Cement | 401 |
| Fly Ash (FA) | 0 |
| Silica Fume (SF) | 0 |
| Water | 165 |
| Air Entertainment | 0.12 |
| Admixture | |
| Super Plasticizer | 2 |
| Carbon Black | 10 |
| Graphite | 0 |
| Coarse Carbon (CC) | 23 |

In some embodiments, a binder composition includes, as a portion of carbon by mass, two (2) to three (3) percent or more carbon black, nano fiber carbon, or the like. In some embodiments, the fine aggregates include a mix of silica sand and coarse carbon. For example, about one (1) percent coarse carbon.

### EXAMPLES

Various examples are shared herein below.

Example 1. A wet-cast concrete composition including a binder composition. The binder composition includes solid carbon equal to or more than one percent by mass of the binder composition. The wet-cast concrete composition further comprises a Portland cement and, aggregates, and water such that the concrete composition slumps.

Example 2. A wet-cast concrete composition of example 1, where the binder composition further comprises supplementary cementitious materials in the range of five percent to fifty percent by mass of the binder composition.

Example 3. A wet-cast concrete composition of example 1, where the solid carbon in a range of one percent to forty percent by mass of the binder composition.

Example 4. A wet-cast concrete composition of example 1, where the solid carbon is a product of methane pyrolysis, and the product includes 95 percent or more carbon.

Example 5. A method of preparing a wet-cast concrete comprises preparing one or more forms, the one or more forms define a shape for the concrete. The method includes combining Portland cement and solid carbon in specified proportions to form a binder composition. The specified proportions include the solid carbon equal to or more than one percent by mass of the binder composition. The method includes mixing the binder composition with aggregates and water to form an uncured concrete mixture such that the concrete composition slumps, and curing the uncured mixture. The method further includes placing the uncured mixture in the one or more forms and allowing the uncured mixture to harden.

Example 6. The method of example 5 further including placing the uncured mixture in a transporter.

Example 7. The method of example 5 or example 6, further including extracting the concrete from the one or more forms.

Example 8. The method of example 5, where the solid carbon is a product of methane pyrolysis, and the product includes 95 percent or more carbon.

In some embodiments, the concrete composition includes coarse carbon in a range from one (1) to ten (10) percent of ingredients.

Each document cited herein was cited to provide clarity to the reader and is incorporated by reference in its entirety. In cases where the present disclosure conflicts with a document incorporated by reference, the present disclosure controls.

To the extent that they are not inconsistent with the specific teachings and definitions herein, all of the U.S. patents, U.S. patent application publications, U.S. patent applications, foreign patents, and foreign patent applications referred to in this specification and/or listed in the Application Data Sheet, including but not limited to any cross-referenced application or priority claim are incorporated herein by reference, in their entirety.

While the disclosure has been described in connection with specific embodiments, it is to be understood that the disclosure is not limited to these embodiments and that alterations, modifications, and variations of these embodiments may be carried out by the skilled person without departing from the scope of the disclosure. It is furthermore contemplated that any part of any aspect or embodiment discussed in this specification can be implemented or combined with any part of any other aspect or embodiment discussed in this specification.

The above description illustrates various embodiments of the present disclosure along with examples of how aspects of particular embodiments may be implemented. The above examples should not be deemed to be the only embodiments or implementations, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

1. A wet-cast concrete composition comprising:
a binder composition including:
solid carbon equal to or more than one percent by mass of the binder composition, and Portland cement;
aggregates; and
water such that the concrete composition slumps.

2. The composition of claim 1, wherein the binder composition comprises supplementary cementitious materials in a range of five percent to fifty percent by mass of the binder composition.

3. The composition of claim 1, wherein the aggregates further comprise coarse aggregates and fine aggregates.

4. The composition of claim 3, wherein the fine aggregates include silica sand or coarse carbon.

5. The composition of claim 1, wherein the solid carbon is selected from the group consisting of carbon black, nano carbon, nano fiber carbon, micro carbon, or graphite.

6. The composition of claim 1, wherein the solid carbon is in a range of one percent to forty percent by mass of the binder composition.

7. The composition of claim 1, wherein the binder composition comprises the Portland cement in a range of ten percent to ninety-eight percent by mass of the binder composition.

8. The composition of claim 1, wherein the concrete mixture slumps more than 25 mm in a standard slump test.

9. A method of preparing a wet-cast concrete comprising:
preparing one or more forms, wherein the one or more forms refer to a shape of the concrete;
combining Portland cement and solid carbon in specified proportions to form a binder composition, wherein the specified proportions include the solid carbon equal to or more than one percent by mass of the binder composition;
mixing the binder composition with water and aggregates to form an uncured concrete mixture such that the concrete composition slumps; and
placing the uncured concrete mixture in one or more forms.

10. The method of claim 9 further comprising curing the uncured mixture.

11. The method of claim 9 further comprising compacting the uncured mixture using one or more compactors.

12. The method of claim 9 further comprising extracting the contract from the one or more forms.

13. The method of claim 9, wherein the aggregates further comprise coarse aggregates and fine aggregates.

14. The method of claim 13, wherein the fine aggregates include silica sand or coarse carbon.

15. The method of claim 9, wherein the solid carbon is selected from the group consisting of carbon black, coarse carbon, nano carbon, nano fiber carbon, micro carbon, or graphite.

16. The method of claim 9, wherein the binder composition comprises solid carbon in a range of one percent to forty percent by mass of the binder composition.

17. The method of claim 9, wherein the binder composition comprises supplementary cementitious materials in a range of five percent to fifty percent by mass of the binder composition.

18. The method of claim 9, wherein the binder composition comprises the Portland cement in a range of ten percent to ninety-eight percent by mass of the binder composition.
